(19) United States
(12) Patent Application Publication
(10) Pub. No.: US 2026/0183869 A1
(43) Pub. Date: Jul. 2, 2026

(54) METHOD AND DEVICE FOR THE LASER WELDING OF AT LEAST TWO CONDUCTOR PIECES, AND ARRANGEMENT OF AT LEAST TWO CONDUCTOR PIECES INTEGRALLY CONNECTED TO ONE ANOTHER

(71) Applicant: TRUMPF LASER SE, Schramberg (DE)

(72) Inventors: Oliver BOCKSROCKER, Sachsenheim (DE); Patrick HAUG, Unteriflingen (DE); Philipp SCHEIBLE, Illingen (DE)

(21) Appl. No.: 19/543,938

(22) Filed: Feb. 19, 2026

Related U.S. Application Data
(63) Continuation of application No. PCT/EP2024/073379, filed on Aug. 20, 2024.

(30) Foreign Application Priority Data
Aug. 24, 2023 (DE) 10 2023 122 748.3

(51) Int. Cl. B23K 26/22

(52) U.S. Cl. CPC B23K 26/22

(57) ABSTRACT

A method for the laser welding of two conductor pieces includes providing an elongated first conductor piece having a first end section and a first end face, and providing an elongated second conductor piece having a second end section and a second end face. The first end face is arranged adjacent to the second end face. The method further includes generating at least two laser spots on the first end face and/or the second end face. Each of the at least two laser spots has a core region and a ring region. An average laser power density in the core region is higher than an average laser power density in the ring region. The method further includes moving the at least two laser spots. The at least two laser spots generate a common melt pool that extends at least partially over the first end face and the second end face.

### CROSS REFERENCE TO RELATED APPLICATIONS

This application is a continuation of International Application No. PCT/EP 2024/073379 (WO 2025/040689A1), filed on Aug. 20, 2024, and claims benefit to German Patent Application No. DE 10 2023 122 748.3, filed on Aug. 24, 2023. The aforementioned applications are hereby incorporated by reference herein.

### FIELD

Embodiments of the present invention relate to a method for the laser welding of at least two conductor pieces, an arrangement of at least two conductor pieces integrally connected to one another, and a device for the laser welding of at least two conductor pieces.

### BACKGROUND

The welding of conductor pieces together using a laser beam is known from the prior art. A laser beam can be used to generate a melt pool that extends over all the conductor pieces to be welded. To do this, the laser beam is moved back and forth between the individual conductor pieces. This generates a molten bead that connects all the conductor pieces to be welded together.

To reduce the processing time, the laser power is usually increased. The disadvantage is that the increase in laser power is limited, as the local heat input could otherwise lead to an asymmetrical formation of the molten bead. An asymmetrical weld bead tends to tilt, leading to a poorer welding result. Furthermore, this can lead to an increase in splatter, in particular at the beginning of the process.

Another disadvantage is that there is usually a gap between the conductor pieces to be welded, over which the laser beam is inevitably moved. This allows radiation to enter the gap and interact with material outside the welding zone (process zone). Interaction of the laser beam with material (e.g., the conductor piece) outside the welding zone is undesirable. Furthermore, the energy that is diverted into the gap is not available for the welding process.

### SUMMARY

Embodiments of the present invention provide a method for the laser welding of at least two conductor pieces. The method includes providing an elongated first conductor piece having a first end section and a first end face, and providing an elongated second conductor piece having a second end section and a second end face. The first end face is arranged adjacent to the second end face. The method further includes generating at least two laser spots on the first end face and/or the second end face. Each of the at least two laser spots has a core region and a ring region. An average laser power density in the core region is higher than an average laser power density in the ring region. The method further includes moving the at least two laser spots. The at least two laser spots generate a common melt pool that extends at least partially over the first end face and the second end face.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a perspective view of end sections with end faces of two conductor pieces, wherein four laser spots are moved on the end faces according to a first exemplary embodiment;

FIG. 2 schematically shows a perspective view of end sections with end faces of two conductor pieces, wherein four laser spots are moved on the end faces according to a second exemplary embodiment;

FIG. 3 schematically shows a perspective view of end sections with end faces of two conductor pieces, wherein four laser spots are moved on the end faces according to a third exemplary embodiment; and

FIG. 4 schematically shows a top view of a laser spot according to some embodiments.

### DETAILED DESCRIPTION

Embodiments of the present invention provide a method and a device for the laser welding of at least two conductor pieces and an arrangement of at least two conductor pieces integrally connected to one another, wherein the above disadvantages are eliminated.

According to some embodiments, a method for laser welding of at least two conductor pieces is provided. The conductor pieces can be electrically conductive elements, in particular of metal (e.g., copper). The conductor pieces can be arranged in a stator of an electric machine. The conductor pieces can be designed for arrangement in a stator of an electrical machine. The conductor pieces, when arranged in a stator and electrically connected to one another, can be used to generate a magnetic field which is needed for the operation of the electric machine.

The conductor pieces can be “hairpins”, which have two elongated (substantially parallel) legs connected to one another by means of a connecting section. The shape of the hairpins usually corresponds to a hairpin. In other words, a hairpin has a (substantially) U-shaped form. The conductor pieces may also be “special pins” that only have one leg. A combination of “hairpins” and “special pins” is also conceivable. The conductor pieces can have a rectangular cross-section.

The method comprises the following steps:
providing an elongated first conductor piece having a first end section and a first end face.

providing an elongated second conductor piece having a second end section and a second end face. The first end face is arranged adjacent to the second end face.

The conductor pieces can be arranged on circular paths in a stator, wherein the conductor pieces protrude from the stator at their end sections. The end sections protruding from the stator can be aligned parallel to one another, in particular oriented along an axial direction of the stator.
generating at least two, in particular at least four, laser spots on the first end face and/or the second end face.

The laser spots each have a core region and a ring region. The average laser power density in the core region is higher than the average laser power density in the ring region. The core region can be circular in shape. The ring region can be ring-shaped. Other geometric shapes for the core region and/or the ring region are also conceivable, e.g., oval or elliptical.

Moving the laser spots. The laser spots can be moved over the first end face and/or the second end face. The laser spots generate a common melt pool that extends at least partially, and in particular completely, over the first end face and the second end face.

This allows the heat input to be distributed more evenly across the end faces of the end sections of the conductor pieces, so that more laser power can be used. This allows for a reduction in downtime and therefore processing time. In addition, the melting of the end faces is more uniform, resulting in a greater gap tolerance and an overall more stable process result with fewer spatters and/or pores. By equalizing the heat input, a more uniform melt pool can be generated, resulting in a more uniform, symmetrical melt bead.

According to a further development, the method can comprise the step of:
moving each of the laser spots along a path. Each laser spot can be moved along its own path. It is also conceivable that the laser spots are moved along a common path. The respective path can extend over the first end face and the second end face. In other words, the respective path can extend over both end faces. This moves the laser spots, in particular, over both end faces. The laser spots can be moved across the gap between the first end face and the second end face. The respective path can be at least in sections, in particular completely, straight, circular and/or elliptical. Other geometric embodiments for the respective path are also conceivable (e.g., rectangular, semicircular, etc.). At least two paths, in particular all paths, can be oriented parallel to one another.

The laser spots can be positioned in a fixed arrangement relative to one another while moving across the end faces. The laser spots can be held in a fixed position relative to one another. The distances between the laser spots can be kept constant. It is also conceivable that the distances between the laser spots can be varied or changed, in particular continuously.

The laser spots can be positioned in a fixed arrangement. The arrangement of the laser spots can be moved translationally along a common path. Alternatively, the arrangement of the laser spots can be rotated along a (common) path around an axis, in particular an optical axis, during movement.

This allows the heat input to be distributed more evenly across the first end face and the second end face.

According to a further development, the method can comprise the step of:
moving each of the laser spots along a path, wherein the respective path extends exclusively over the first end face or the second end face. In other words, the respective path can extend exclusively over the first end face or exclusively over the second end face. Each laser spot can be moved along its own path. The respective path does not extend, in particular, across the gap between the two end faces. This also allows the individual laser spots to be moved exclusively over the first end face or exclusively over the second end face. In particular, the laser spots are not moved over the gap between the two end faces. The respective path can be at least in sections, in particular completely, straight, circular and/or elliptical. Other geometric embodiments for the respective path are also conceivable (e.g., rectangular, semicircular, etc.). At least two paths, in particular all paths, can be oriented parallel to one another.

This prevents one of the laser spots from moving across a gap located between the two end faces. This prevents any radiation from being directed into the gap. This prevents the laser radiation from interacting with material outside of a welding or process zone. All of the laser energy can be used for the welding process.

According to a further development of the method, the laser spots can be moved by means of a scanner optic. The scanner optic can have an imaging ratio of 1.7:1.

Alternatively, it is conceivable that the laser spots could be generated using a fixed optic. It is conceivable that the laser spots could be moved by moving the fixed optic.

This allows the movement of the laser spot to be implemented using simple means.

According to a further development of the method, at least two, and in particular all, laser spots can be identically designed. It is also conceivable that at least two, in particular all, laser spots may be shaped differently.

This simplifies the generation of individual laser spots and/or makes the energy distribution more uniform.

According to a further development of the method, the ring regions of at least two, in particular all, laser spots can overlap each other.

Due to the overlap of the ring regions, the energy input can be further optimized.

According to a further development of the method, the core regions of at least two, in particular all, laser spots can be arranged at a distance from each other. The distance between the laser spots can be at least 20% of the diameter of the laser spots. The core regions of at least two, in particular all, laser spots cannot be arranged in an overlapping manner. In other words, the core regions preferably do not overlap.

The spaced-apart core regions allow the energy intensities to be distributed over a larger surface, thus further optimizing the energy input.

It is conceivable that at least two, in particular all, laser spots can be arranged at a distance from each other. At least two, in particular all, laser spots can be arranged in a non-overlapping manner. In other words, the laser spots preferably do not overlap.

The core regions and/or the ring regions of at least two, in particular all, laser spots can be arranged at a distance from each other. The ring regions of at least two adjacent laser spots can (at their respective outer diameters) touch (have at least one common point).

It is conceivable that at least two, in particular all, laser spots, whose core regions and/or their ring regions may be arranged in an overlapping manner. For example, the ring regions of at least two (adjacent), in particular all, laser spots can overlap. It is conceivable that a ring region of a laser spot overlaps the core region of an adjacent laser spot.

This allows the energy input to be distributed as optimally as possible over a corresponding surface.

According to a further development of the method, at least two, in particular all, laser spots can be generated using an optical multi-fiber. The optical multi-fiber can be designed as a 2-in-1 fiber. At least two, in particular all, laser spots can be identically configured. In particular, the laser spots can have (substantially) the same beam properties.

The 2-in-1 fiber can have a fiber core diameter of 50 μm (micrometers) and a fiber ring diameter of 200 μm.

To generate the laser spots, a laser with a beam quality of SPP (beam parameter product) less than or equal to 4 mm*mrad (millimeters*milliradians) can be used.

To generate the laser spots, an NIR (Near InfraRed) laser (multi-mode) with a power of greater than or equal to 4 kW (kilowatts), in particular greater than 8 kW, preferably 12 kW, can be used.

Alternatively, a laser with a wavelength in the visible range (VIS laser), in particular green or blue, can be used.

This makes the generation of the first laser spot and the second laser spot as simple as possible.

According to a further development, the method can comprise the step of:
varying, in particular oscillating, the average laser power density of at least one laser spot of its core region and/or of its ring region. It is conceivable that the average laser power density of a plurality of, in particular all, laser spots, their respective core regions and/or their respective ring regions can be varied, in particular oscillated.

varying (or oscillating) the average laser power density can be implemented in particular during the welding process. The total laser power can be varied or oscillated during the welding process.

This allows the degree of mixing in the melt pool to be increased or adjusted as desired. This allows the energy input to be further homogenized.

According to a further development of the method, at least two, and in particular all, laser spots can each be generated by means of a laser beam. The individual laser beams can be guided parallel to one another.

At least two, and in particular all, laser spots can each be generated using partial beams. The partial beams can be generated from a common laser beam, e.g., by an optical beam splitter, wedge plate, etc. The partial beams can be guided parallel to one another.

This makes it as easy as possible to generate laser spots that are identical in shape.

The method can comprise the step of:
determining the position of the laser spots on the respective end face. An optical sensor can be used for this purpose. The optical sensor can be camera-based. The optical sensor may be configured as a camera. Alternatively, the sensor can be designed as an interferometric sensor system.

This allows for position detection and/or position control of the respective laser spot. Any potential positioning deviation of the respective laser spot can thus be registered and/or corrected. This ensures and monitors consistent quality in welded connections.

According to a further development, the method can comprise the step of:
moving the laser spots in a rotational movement about an optical axis.

This allows the degree of mixing in the melt pool to be increased or adjusted as desired. This allows the energy input to be further homogenized.

Embodiments of the present invention also provide an arrangement of at least two conductor pieces integrally connected to one another. The materially bonded connection is produced using a method as described above. In particular, the materially bonded connection is a welded connection.

With regard to the advantages that can be achieved, reference is made to the relevant embodiments relating to the method. The measures described in connection with the method and/or explained below may serve to further develop the arrangement.

Embodiments of the present invention also provide a device for the laser welding of at least two conductor pieces.

The device comprises at least one laser source. The laser source is configured to generate at least two, in particular at least four, laser spots. The laser spots each have an, in particular circular, core region and an, in particular ring-shaped, ring region. The average laser power density in the core region is higher than the average laser power density in the ring region.

The device comprises a control unit for controlling the device. The device and/or the control unit are configured to carry out the method as described above. The control unit can be designed as a computer.

With regard to the advantages that can be achieved, reference is made to the relevant embodiments relating to the method. The measures described in connection with the method and/or explained below may serve to further develop the device.

A computer-readable storage medium is proposed, comprising commands which, when executed by a computer, cause it to perform the procedure as described above. With regard to the advantages that can be achieved, reference is made to the relevant embodiments relating to the method. The measures described in connection with the method and/or explained below may serve to further develop the storage medium.

A computer program is proposed, comprising commands which, when executed by a computer, cause it to perform the method according to the above descriptions. With regard to the advantages that can be achieved, reference is made to the relevant embodiments relating to the method. The measures described in connection with the method and/or explained below may serve to further develop the computer program.

A data carrier signal is proposed that characterizes and/or transmits the computer program according to the above designs. The data carrier signal can be received, for example, via an optional data interface of a computer. With regard to the advantages that can be achieved, reference is made to the relevant embodiments relating to the computer program. The measures described in connection with the computer program and/or explained below may serve to further develop the data carrier signal.

In the following description and in the figures, corresponding components and elements have the same reference signs. For the sake of better clarity, all reference signs are not reproduced in all of the figures.

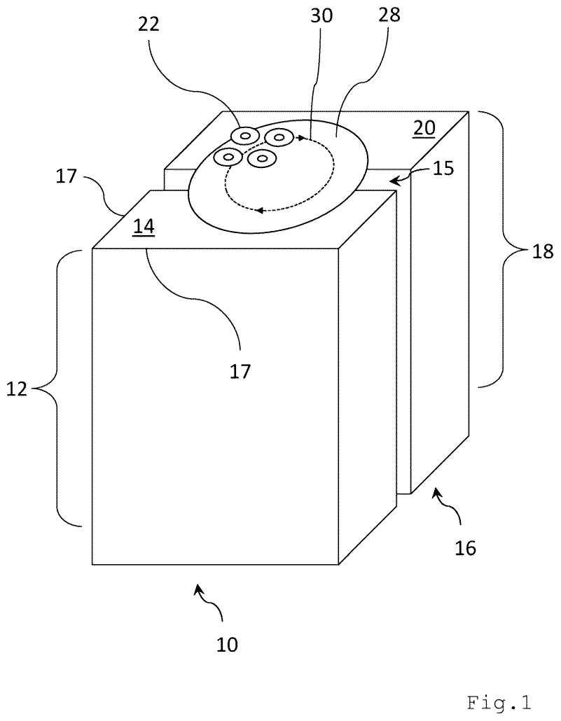

The method according to embodiments of the invention for the laser welding of at least two conductor pieces 10, 16 is explained below with reference to FIGS. 1 to 4.

The method comprises the steps of:
providing an elongated first conductor piece 10 having a first end section 12 and a first end face 14.
providing an elongated second conductor piece 16 having a second end section 18 and a second end face 20.

In this case, the end sections 12, 18, and the two end faces 14, 20 are arranged adjacent to one another. A gap 15 is arranged between the two end faces 14, 20.

The conductor pieces 10, 16 in this case have a rectangular cross-section. Thus, the two end faces 14, 20 also have a rectangular shape. The two end faces 14, 20 each have four edges 17, which each represent an outer boundary of the respective end faces 14, 20.

After the two end faces 14, 20 have been provided, four laser spots 22 are generated on the end faces 14, 20 in this case.

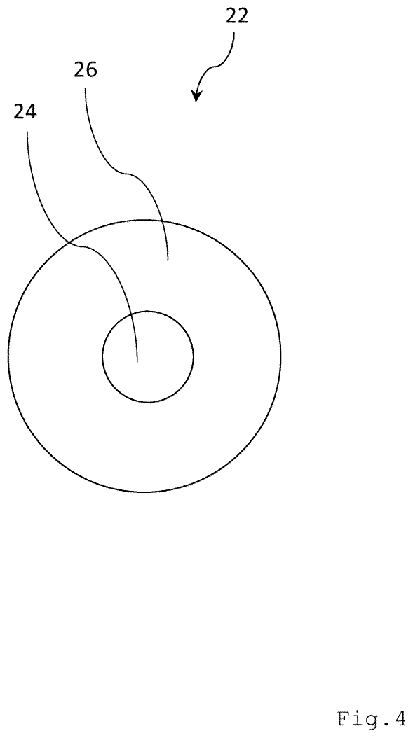

The laser spots 22 each have a circular core region 24 and a ring-shaped ring region 26 (see FIG. 4). The average laser power density in the core region 24 is higher than the average laser power density in the ring region 26. In other words, the laser intensity in the core region 24 is higher than the laser intensity in the ring region 26.

The laser spots 22 are moved over the two end faces 14, 20. The laser spots 22 generate a common melt pool 28. The common melt pool 28 extends at least partially over the first end face 14 and the second end face 20. A melt bead then forms from the common melt pool 28, which connects the two end sections 12, 18 in a materially bonded manner.

The four laser spots 22 are arranged at a distance from each other. In other words, the 22 laser spots do not overlap. It is also conceivable that the laser spots 22, their ring regions 26 and/or their core regions 24 may overlap. It is conceivable that the ring regions 26 of the laser spots 22 can overlap, wherein the core regions 24 are spaced apart from each other.

The four laser spots 22 can be moved using a scanner optic (not shown). It is also conceivable that the four laser spots 22 are generated by means of a fixed optic, wherein the fixed optic can be moved to move the laser spots 22.

In this case, all four laser spots 22 are identically designed.

The four laser spots 22 can be generated by means of an optical multi-fiber, in particular a 2-in-1 fiber (not shown).

The laser spots 22 can each be generated by means of a laser beam. The laser beams can be guided parallel to one another. The parallel laser beams can in particular be designed as partial beams of a common laser beam, which are preferably generated by means of a beam splitter (not shown).

The average laser power density of the laser spots 22, or their core regions 24 and/or their ring regions 26, can be varied, in particular oscillated. It is also conceivable that intensity ramps can be driven from core region 24 to ring region 26 (or vice versa). In other words, the average laser intensity can be continuously increased (e.g., at the end of the welding process) and/or decreased (e.g., at the beginning of the welding process) from core region 24 to ring region 26.

It is also conceivable that the position of the laser spots 22 on the end faces 14, 20 is determined, in particular for position monitoring and control. This can be implemented using an optical sensor (not shown).

FIG. 1 illustrates a movement of the laser spots 22 according to a first exemplary embodiment.

In this case, the laser spots 22 are moved clockwise. A counter-clockwise movement is also conceivable.

The four laser spots 22 are arranged in a rectangular (square) arrangement. It is conceivable that this arrangement can be rotated during the movement of the laser spots 22, in particular around an optical axis. It is also conceivable that the four laser spots 22 can be moved translationally. In particular, the relative position of the laser spots 22 to one another can be fixed or not changed.

The four laser spots 22 are each moved along a path 30 in this case. In other words, each of the four laser spots 22 is moved along its own path 30. For the sake of clarity, the four paths 30 are indicated in FIG. 1 by means of only a dashed line.

In this case, the paths 30 overlap. It is also conceivable that the paths 30 do not overlap.

The paths 30 extend circularly over the first end face 14 and the second end face 20. It is conceivable that the paths 30 each have an elliptical extent.

In this case, the laser spots 22 are also moved over the gap 15. Due to the spaced arrangement of the laser spots 22, all laser spots 22 never enter the gap 15 at the same time. In other words, at least one laser spot 22 is always arranged, at least in parts, on the first end face 14 or on the second end face 20.

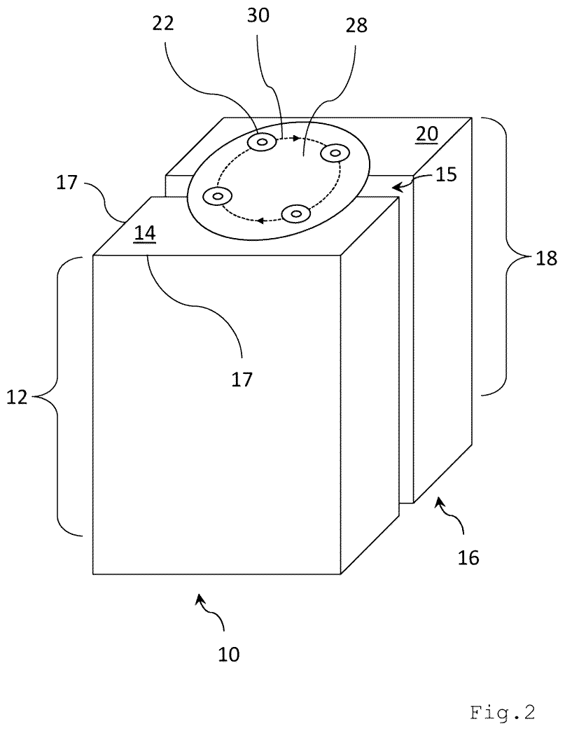

FIG. 2 illustrates a movement of the laser spots 22 according to a second exemplary embodiment. The second exemplary embodiment differs from the first exemplary embodiment shown in FIG. 1 in the following ways:
The four laser spots 22 are moved along a common, in this case circular, path 30. The laser spots 22 are arranged equidistantly (or evenly) distributed along the common path 30.

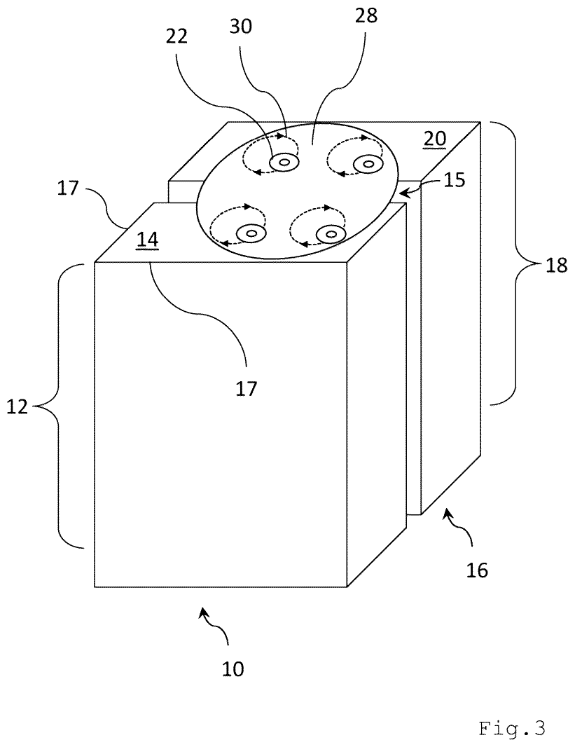

FIG. 3 illustrates a movement of the laser spots 22 according to a third exemplary embodiment. The third exemplary embodiment differs from the first exemplary embodiment shown in FIG. 1 in the following ways:
The four laser spots 22 are each moved along a path 30, which in this case is circular. The paths 30 each extend only on the first end face 14 or on the second end face 20.

In this case, two paths 30 run on the first end face 14 and two further paths 30 run on the second end face 20. In this case, the paths 30 do not run over the gap 15. The paths 30 do not intersect or touch each other. The paths 30 are spaced apart from each other.

Since the paths 30 do not pass over the gap 15, the respective laser spots 22 are also not moved over the gap 15. Thus, two laser spots 22 are moved exclusively on the first end face 14 and two further laser spots 22 are moved exclusively on the second end face 20.

In particular, the laser spots 22 are always kept at a distance from the edges 17. The laser spots 22 can be held at a distance from the gap 15. This can prevent (or at least reduce the probability of) a laser spot 22 entering the gap 15.

FIG. 4 schematically shows a plan view of a laser spot 22. This could be a laser spot 22 from one of FIGS. 1 to 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for the laser welding of at least two conductor pieces, the method comprising:
providing an elongated first conductor piece having a first end section and a first end face;
providing an elongated second conductor piece having a second end section and a second end face, wherein the first end face is arranged adjacent to the second end face;
generating at least two laser spots on the first end face and/or the second end face, wherein each of the at least two laser spots has a core region and a ring region, wherein an average laser power density in the core region is higher than an average laser power density in the ring region; and
moving the at least two laser spots, wherein the at least two laser spots generate a common melt pool that extends at least partially over the first end face and the second end face.

2. The method according to claim 1, wherein the at least two laser spots comprise at least four laser spots.

3. The method according to claim 1, further comprising:
moving each respective laser spot of the at least two laser spots along a respective path, wherein the respective path extends over the first end face and the second end face.

4. The method according to claim 3, wherein the respective path is straight, circular, and/or elliptical, at least in sections.

5. The method according to claim 1, further comprising:
moving each respective laser spot of the at least two laser spots along a respective path, wherein the respective path extends exclusively over the first end face or the second end face.

6. The method according to claim 1, wherein the at least two laser spots are moved by a scanner optic.

7. The method according to claim 1, wherein the at least two laser spots are identically configured.

8. The method according to claim 1, wherein the ring regions of the at least two laser spots overlap each other.

9. The method according to claim 1, wherein the core regions of the at least two laser spots are arranged spaced apart from each other.

10. The method according to claim 9, wherein a distance between the at least two laser spots is at least 20% of a laser spot diameter.

11. The method according to claim 1, wherein the at least two laser spots are generated by an optical multi-fiber.

12. The method according to claim 1, further comprising:
varying the average laser power density of the core region and/or the average laser power density of the ring region of at least one laser spot of the at least two laser spots.

13. The method according to claim 1, wherein the at least two laser spots are generated by two laser beams, wherein the two laser beams are guided parallel to one another.

14. The method according to claim 1, further comprising:
moving the at least two laser spots in a rotational movement about an optical axis.

15. An arrangement of at least two conductor pieces integrally connected to one another by a method according to claim 1.

16. A device for laser welding of at least two conductor pieces, the device comprising:
a laser source configured to generate at least two laser spots, wherein each of the at least two laser spots has a core region and a ring region, wherein an average laser power density in the core region is higher than an average laser power density in the ring region, and
a control unit for controlling the device, wherein the control unit is configured to carry out the method according to claim 1.

17. A non-transitory computer-readable storage medium comprising program steps stored thereon, the program steps, when executed by one or more processors, causing performance of a method according to claim 1.
